(19) United States
(12) Patent Application Publication
(10) Pub. No.: US 2006/0010043 A1
(43) Pub. Date: Jan. 12, 2006

(54) Method and apparatus for returning rentals

(76) Inventor: Andrew Frederick Abramson, Boston, MA (US)

Correspondence Address: Andrew Abramson, 33 Concord Square - Unit 1, Boston, MA, 02118, US

(21) Appl. No.: 10/886,093

(22) Filed: Jul. 6, 2004

(51) Int. Cl. G06F 17/60

(52) U.S. Cl. 705/26

(57) ABSTRACT

The invention relates to a method for returning a rental including receiving a communication about a rental from a client operated by a renter. The method further includes the steps of determining the source of the rental, or rental store, obtaining the rental, and delivering the rental to the source.

### FIELD OF THE INVENTION

The invention relates to rentals. In particular, the invention relates to a method and apparatus for returning rentals that a customer rents from a rental store.

### BACKGROUND OF THE INVENTION

The movie rental industry has exploded over the past several decades and now provides an additional revenue stream for movies following their theatre showing. Rental stores such as Blockbuster Inc.® enable people to rent one or more rentals (e.g., movies or video games) from the store. After watching or playing a rental, the customer typically has to travel back to the rental store to return the rental. As people today lead increasingly busy lives, the trip back to the rental store often causes unneeded stress and aggravation. For example, the returning of the rental may be another item on the already full list of chores that the renter has to complete. Besides potentially increasing the renter's irritation, a video store may also increase the fees charged to the renter when the renter does not return the rental by its due date. Specifically, a rental store typically charges late fees for each day that the renter is late in returning the rental.

Recently, companies such as Netflix® have enabled customers to receive one or more rentals in the mail, watch or use the rentals for any amount of time, and then mail the rentals back to the company. Thus, these companies typically eliminate late fees. These companies, however, also eliminate all trips to a rental store. Therefore, these companies rob a customer from experiencing the initial trip to the rental store to rent an item. For example, a customer of one of these companies cannot read what a rental is about (e.g., by reading the back cover of the rental box) before deciding to rent the rental. In effect, the customer has to select a rental based on external influences, such as reviews of the movie by friends, family, or critics. The renter cannot, unfortunately, hold the movie's box in his or her hands before deciding whether to rent the movie.

Thus, there remains a need of providing more flexibility than conventional approaches offered to a customer of a rental store after the customer rents a rental.

### SUMMARY OF THE INVENTION

The present invention potentially helps decrease the stress and aggravation often felt by people who have the chore of returning rentals.

In one aspect, the invention relates to a method for returning a rental including receiving a communication about a rental from a client operated by a renter. The method further includes the steps of determining the source of the rental, or rental store, obtaining the rental, and delivering the rental to the source.

In one embodiment, the communication from the client includes login information, such as a username of the renter, a password of the renter, and/or information about the renter. The communication from the client can also include information about the rental and/or information about the source. The information about the renter can include the renter's telephone number, address, and/or email address. The information about the rental can include the title of the rental. The information about the rental store can include the name of the store, the telephone number of the store, the address of the store, the closing time of the store, directions to the store, hours of operation of the store, web page address of the store, and/or a contact at the store.

In some embodiments, the method includes determining the current time that the communication is made. The method can also include determining a predetermined time at which the communication from the client has to be received to return the rental on the same day that the communication was received. The method can also include determining whether the communication is received before the predetermined time. The method can also include providing a credit to the renter if the communication is received before the predetermined time and the rental is not returned until at least one day after the communication was received. The determining of the source of the rental can occur by retrieving information about the source of the rental from a database. In one embodiment, the source can be determined based on previous communications (e.g., a default source of the rental for a particular user). In one embodiment, the obtaining of the rental further includes determining a location of the rental.

In another aspect, the invention relates to a rental return module for facilitating the return of a rental. The rental return module can include a client communications module receiving a communication from a client about a rental, a source determining module determining the source of the rental, and a returning device communications module communicating, to a returning device, information about at least one of the rental and the source of the rental.

In one embodiment, the rental return module receives, as the communication from the client, login information for a renter of the rental. The login information can also include a username of the renter, a password of the renter, and information about the renter. The communication from the client can also include information about the rental, information about the source, and/or information about a renter operating the client. The information about the renter can include, for instance, the renter's telephone number and/or address.

In one embodiment, the source determining module determines a name of the rental store, telephone number of the store, address of the store, closing time of the store, directions to the store, hours of operation of the store, and/or contact at the store. In further embodiments, the rental return module includes a database maintaining information about the rental, the source of the rental, the renter, and/or the client.

### BRIEF DESCRIPTION OF THE DRAWINGS

FIG. 1 is a block diagram of an embodiment of a client computer interacting with a rental return module to facilitate the return of a rental to a rental store.

FIG. 2 is a flow chart of an embodiment of the steps performed when returning the rental back to the rental store.

FIG. 3 is a more detailed block diagram of the rental return module.

FIG. 4 is a block diagram of an embodiment of a screen provided by the rental return module to facilitate the return of the rental.

### DETAILED DESCRIPTION

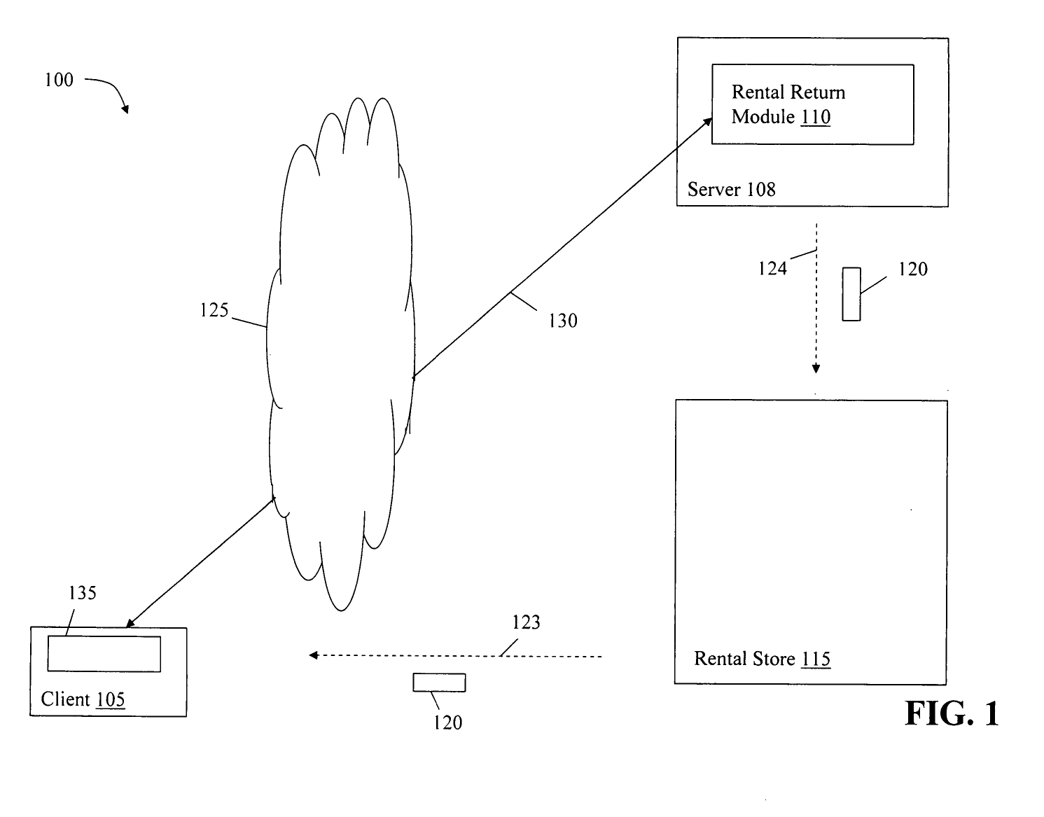

Referring to FIG. 1, a rental return system 100 includes a client 105, a server 108 having a rental return module 110, and a rental source (or store) 115. A customer, also referred to below as a renter, of the rental store 115 travels to the rental store 115 to rent an item (i.e., a rental) 120. The movement of the rental 120 to the renter is shown with a renter directional arrow 123. The renter uses the rental 120, such as by watching or playing the rental 120. The renter (i.e., the client 105) then, at some later time, communicates with the rental return module 110 executing on the server 108 to facilitate the return of the rental without requiring the renter to travel back to the rental store 115. The movement of the rental 120 back to the rental store 115 is shown with rental store directional arrow 124.

Examples of the rental 120 include a movie (e.g., stored on a Video Home System (VHS) tape or a Digital Video Disk (DVD)), music (e.g., stored on a Compact Disk (CD)), a video game (e.g., a Sony® Playstation® game or an Xbox® game), a video game system (e.g., a Sony® Playstation® system or an Xbox® system), a sound system, electronic equipment, a computer, computer-related equipment (e.g., a printer), a telephone, or any other item that a user can rent from a rental store 115.

The rental store 115 is a video store, such as Blockbuster Inc.®. Although described above and below as a video store, the rental store 115 can be any physical location that a customer has to travel to return a rental 120.

The client 105 is typically a personal computer that can download information from the server 108 over a network 125. The client 105 can be any personal computer (e.g., based on a microprocessor from the 680x0 family, PowerPC, PA-RISC, MIPS families, an Intel microprocessor, an Advanced Micro Devices microprocessor), smart or dumb terminal, network computer, wireless device, information appliance, workstation, minicomputer, mainframe computer, cellular phone, personal digital assistant, mobile computing device (e.g., a Blackberry® device developed by Research In Motion Limited of Waterloo, Ontario or a Treo® manufactured by palmOne, Inc. of Milpitas, Calif.), or any other device that can communicate with the server 108. Although the renter is described above and below as the individual who rented the rental 120 from the rental store 115, the renter may alternatively be another individual who is operating the client 105 and requests a return of the rental 120. For example, the renter may be the rental store customer's friend who makes a request for the return of the rental 120 after the customer and friend watch or play the rental 120.

The client 105 is in communication with the server 108 (and, therefore, the rental return module 110) over a client-server communication channel 130. In one embodiment, the communication channel 130 is established over the network 125. The network 125 can be a local-area network (LAN), a wide area network (WAN), or a network of networks such as the Internet or the World Wide Web (i.e., web).

In one embodiment, the client 105 includes a web browser 135, such as INTERNET EXPLORER® developed by Microsoft Corporation in Redmond, Wash., to connect to the web. In one embodiment, the client 105 uses the web browser 135 to communicate with the server 108 (i.e., the rental return module 115). In a further embodiment, the web browser 135 uses the existing Secure Socket Layer (SSL) support for communications to the server 108. SSL is a secure protocol developed by Netscape Communication Corporation of Mountain View, Calif., and is now a standard promulgated by the Internet Engineering Task Force (IETF). Further, the server 108 can be any device described above for the client 105.

To facilitate the return of the rental 120, the renter communicates with the rental return module 110. The rental return module 110 can then determine the location of the rental store 115. In one embodiment, an individual (i.e., someone other than the renter and somehow associated with the rental return module 110) picks up the rental 120 from the renter and delivers the rental 120 back to the rental store 115.

The rental return module 110 can be a software module that enables the renter to, using the client 105, request the return of the rental 120. In one embodiment, the rental return module 110 is or provides a web page that the renter accesses to request the return of the rental 120. The rental return module 110 can be written in any computer language, such as C++, Perl, Java, HTML, and the like.

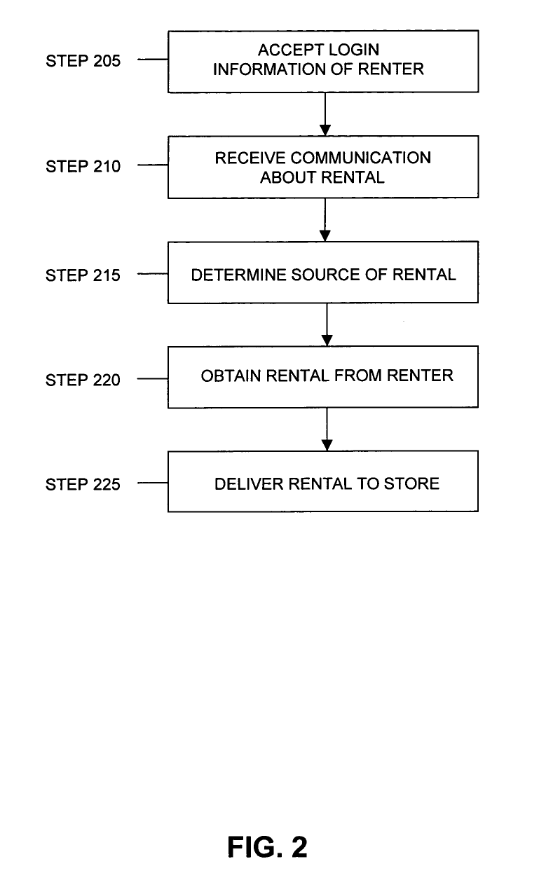

FIG. 2 is a flow chart illustrating an embodiment of the steps performed to return a rental 120 to the rental store 115. The rental return module 110 receives login information that the renter communicates over the network 135 (step 205). The login information can be any information that identifies a renter. Examples of the login information can include one or more of a renter's user name, password, telephone number, address, social security number, and/or email address. Another example includes biometric information, such as a renter's voice pattern, a renter's retina (e.g., obtained via a retinal scan), and a renter's fingerprints.

In one embodiment, the renter receives a username and password from the rental return module 110 and then provides information about himself, such as the renter's address and telephone number. At subsequent login attempts, the renter logs in using the username and password. Moreover, in one embodiment, the renter does not have to provide information about himself. Further, the renter can change any information about himself (e.g., the renter's address) at any time.

For example, if the renter is someone who has previously communicated with the rental return module 110, the renter already has login information that the renter can enter. If, however, the renter has not previously communicated with the rental return module 110, the rental return module 110 assigns new login information (e.g., a new user name and a new password) to the renter.

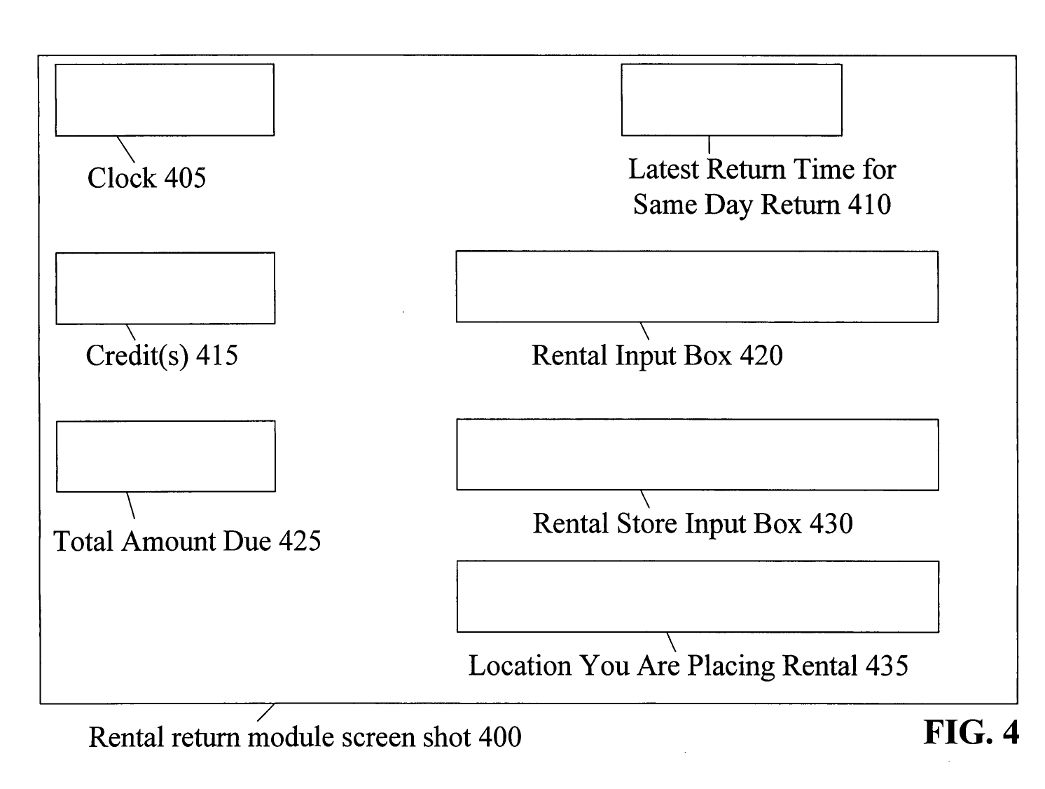

After receiving the login information from the renter, the rental return module 110 then receives communication from the renter about the rental 120 (step 210). As further described below with respect to FIG. 4, the communication about the rental 110 can include the rental's title, the rental store 115, and/or the location at which the renter is leaving the rental 120 for pickup, such as in the renter's mailbox. In one embodiment, all communications between the client 105 and the rental return module 110 are secure.

In one embodiment, the rental return module 110 determines the rental source 115 of the rental 120 (step 215). For example, if this is the first time that the renter communicates with the rental return module 110, the renter inputs the rental store 115 that the renter rented from. If the renter has communicated with the rental return module 110 in the past, the rental return module 110 can determine that the rental store 115 for this rental 120 is the same rental store 115 as the store 115 from the previous rental 120 (i.e., a default rental store 115 for the particular renter). In further embodiments, the renter can change this default rental store at any time. In one embodiment, the rental return module 110 locates information about the rental store 115 for the particular renter from a database.

The rental 120 is then obtained from the renter (step 220). As described in more detail below, in one embodiment a driver associated with the rental return module 110 (e.g., in communication with the rental return module 110) drives to the address of the renter (e.g., the address provided by the renter as part of the login information) and picks up the rental 120. The driver can be an individual driving a vehicle, such as a car, bus, taxi, truck, tractor, motorcycle, bicycle, boat, skateboard, airplane, rollerblades, skates, moped, or skis. The driver can also be walking, jogging, running, rollerblading, etc. In yet another embodiment, the driver can be an automated or controlled machine, such as a robot or radio controlled vehicle. Once the driver obtains the rental 120, the driver then delivers the rental 120 to the rental store 115 (step 225).

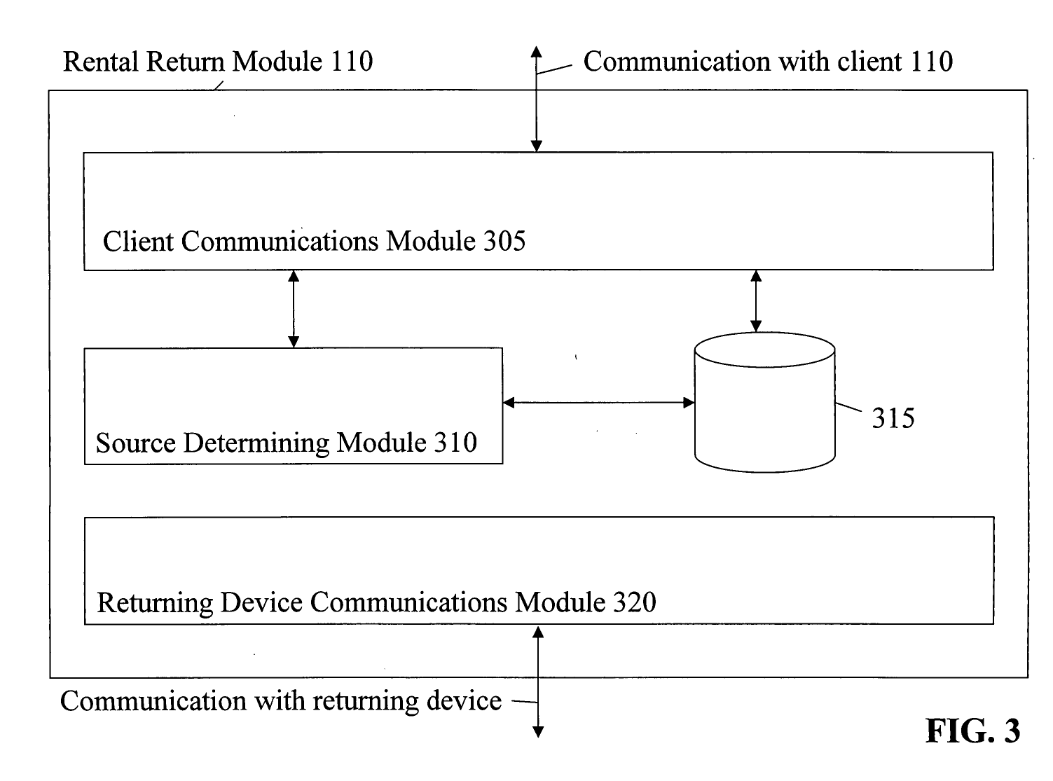

Referring to FIG. 3, the rental return module 110 can include a client communications module 305, a source determining module 310, a database 315, and a returning device communications module 320. The client communications module 305 receives and transmits communications from and to the client 105 over the network 125. For example, the client communications module 305 receives the renter's login information and the information about the rental 120 over the network 125.

In one embodiment, the client communications module 305 is in communication with the database 315. The client communications module 305 can, for instance, receive the renter's login information and retrieve specific account information for the renter from the database 315, such as if the renter has an outstanding balance or any credits not yet used (as described in more detail below with respect to FIG. 4). The client communications module 305 can then communicate the specific account information back to the renter, such as by displaying information specific to the renter on the web page being viewed by the client 105.

In one embodiment, the client communications module 305 communicates with the source determining module 310 in order to determine the rental source 115 for the rental 120. For example, the source determining module 310 communicates with the client communications module 305 to determine which renter's account to access and then retrieves information about the previous rental store 115 that the renter rented from. The rental store information can include the rental store's address, phone number, directions to the rental store 115, and the like. In another embodiment, the source determining module 310 enables the renter to input the rental store 115 for returning the rental 120 as a communication from the client 105.

In one embodiment, the returning device communications module 320 communicates with a returning device after receiving the communication(s) from the client 105 to facilitate the return of the rental 120. For example, upon a request from the client 105 to return a particular rental 120 and upon the determination of the rental source 115, the rental return module 110 communicates information about the rental 120 to a returning device. The returning device is any device that can help facilitate the returning of the rental 120 to the rental store 115, such as any of the devices described above for the client 105. Thus, a driver, as described above, carrying the returning device can receive a communication (e.g., email, page, call) on the returning device from the rental return module 110. The driver can use the communication(s) from the rental return module 110 to locate and return the rental 120 to the correct rental store 115. In one embodiment, the returning device is part of the vehicle driven by the driver.

The information sent by the rental return module 110 to the returning device can include the rental source's phone number, address, time of request (i.e., communication) received from the client 105, time until the rental store 115 closes for the day, location of the rental 120 (e.g., where the renter is going to leave the rental 120 for pickup, such as in the renter's mailbox), and the like.

In one embodiment, these modules 305, 310, 315, 320 are independent modules operating on the rental return module 110. Alternatively, one or more of the modules 305, 310, 315, 320 are combined into a single module. Moreover, although illustrated as part of the rental return module 110, the modules 305, 310, 315, 320 can be executing on another computer and be in communication with the rental return module 110.

FIG. 4 illustrates an embodiment of a screen shot 400 of the rental return module 110. The screen shot 400 is an example of a user interface after the renter logs into the rental return module 110. In one embodiment, the screen shot 400 includes a clock 405 and a “Latest Return Time for Same Day Return” box 410. The clock 405 displays the current time of day. The “Latest Return Time for Same Day Return” box 410 displays a predetermined time at which a renter can request returning the rental 120 and the return occurs on the same day that the request is made. The predetermined time may be, for instance, a particular time before the closing of the rental store 115. Thus, the predetermined time may vary depending on the rental store 115 (e.g., if different rental stores 115 have different store hours).

The screen shot 400 also includes a credit(s) box 415. The credit(s) box 415 displays the amount of credit that a renter has towards future charges. A renter can receive a credit when, for instance, the renter requests a return before the time displayed in the “Latest Return Time for Same Day Return” box 410 and the rental 120 is not returned on the same day. In one embodiment, the renter incurs a late fee because the rental 120 had not been returned on its due date (if its due date was the day the request was made or one or more days after the request was made). The amount of the late fee can be credited to the renter's account so that the renter can obtain a discount to a return or a free return in the future.

The screen shot 400 can also include a rental input box 420. The rental input box 420 enables the renter to enter the rental 120 that the renter requests to have returned. In one embodiment, the rental input box 420 has a list of rental titles that the renter can choose from. In another embodiment, the renter types in the title of the rental 120 in the rental input box 420. Moreover, after a renter enters in the title of a rental 120 for return, the rental return module 110 can then list the title, such as below the rental input box 420. This way, the renter can enter multiple titles into the rental input box 420 and see which titles the renter had previously entered. In some embodiments, the renter does not submit input for the rental input box 420, such as if the renter is only requesting the return of a single rental 120.

The screen shot 400 can also include a “Total Amount Due” box 425 that displays the total amount due for the returns of the rental(s) 120. The “Total Amount Due” box 425 can also take into account the credit(s). In alternative embodiments, the screen shot 400 has one display box illustrating the total amount due before any credits are applied and another display box illustrating the total amount due after the credits are applied.

In one embodiment, the screen shot 400 also includes a Rental Store Input Box 430. The Rental Store Input Box 430 enables a renter to enter the rental store 115 at which the rental 120 has to be returned. The Rental Store Input Box 430 can also have a default entry for each renter. For example, if a renter usually rents from a particular rental store 115, the Rental Store Input Box 430 can display this rental store 115 as a default. Moreover, the Rental Store Input Box 430 can have a selection list listing all of the rental stores 115 in the renter's area. This list may include the name of the rental store as well as the address and phone number. In further embodiments, the renter can notify the rental return module 110 when information associated with the rental store 115 has changed. In some embodiments, the rental return module 110 can communicate with the rental stores 115 themselves (e.g., computers at the stores 115) to update the information that the rental return module 110 stores and/or displays. Thus, the rental store 115 can communicate with the rental return module 110 if its information has changed, such as if the store 115 has moved or has obtained a new telephone number.

The screen shot 400 can also include a “Location You Are Placing Rental” input box 435. This input box 435 enables a renter to designate a location that the renter will leave the rental 120 for return to the rental store 115. For example, the renter may enter that the renter is going to leave the rental 120 in the renter's mailbox for pickup. Thus, when a driver associated with the rental return module 110 wants to obtain the rental 120 for return, the driver knows where to find the rental 120. Moreover, this input box 435 (and the other input boxes mentioned above) may have a default setting, such as if the renter has always left previous return rentals 120 in the default setting (e.g., the renter's mailbox). This input box 435 may also have a drop down list containing common locations that renters leave the rental 120, such as a renter's mailbox, outside of the renter's door, outside of the renter's building's door, and the like.

Having described certain embodiments of the invention, it will now become apparent to one of skill in the art that other embodiments incorporating the concepts of the invention may be used. Therefore, the invention should not be limited to certain embodiments, but rather should be limited only by the spirit and scope of the following claims.

We claim:

1. A method for returning a rental comprising:
(a) receiving a communication about a rental from a client operated by a renter;
(b) determining the source of the rental;
(c) obtaining the rental; and
(d) delivering the rental to the source.

2. The method of claim 1 wherein the communication from the client further comprises login information.

3. The method of claim 2 wherein the login information further comprises at least one of a username of the renter, a password of the renter, and information about the renter.

4. The method of claim 2 wherein the communication from the client further comprises at least one of information about the rental, information about the source, and information about the renter.

5. The method of claim 3 wherein the information about the renter further comprises a telephone number and an address of the renter.

6. The method of claim 4 wherein the information about the renter further comprises a telephone number and an address of the renter.

7. The method of claim 4 wherein the information about the rental further comprises a title of the rental.

8. The method of claim 4 wherein the information about the source further comprises at least one of name of the source, telephone number of the source, address of the source, closing time of the source, directions to the source, hours of operation of the source, and contact at the source.

9. The method of claim 1 further comprising determining the current time that the communication is made.

10. The method of claim 9 further comprising determining a predetermined time at which the communication has to be received for the rental to be returned on day that the communication is received.

11. The method of claim 10 further comprising determining whether the communication is received before the predetermined time.

12. The method of claim 11 further comprising providing a credit to the renter if the communication is received before the predetermined time and the rental is returned on at least one day after the communication was received.

13. The method of claim 1 wherein the determining of the source of the rental further comprises retrieving information about the source of the rental from a database.

14. The method of claim 1 wherein the obtaining of the rental further comprises determining a location of the rental.

15. A rental return module for facilitating return of a rental comprising:
(a) a client communications module receiving a communication from a client about a rental;
(b) a source determining module determining the source of the rental; and
(c) a returning device communications module communicating, to a returning device, information about at least one of the rental and the source of the rental to facilitate the return of the rental to the source.

16. The rental return module of claim 15 wherein the communication from the client further comprises login information for a renter of the rental.

17. The rental return module of claim 16 wherein the login information further comprises at least one of a username of the renter, a password of the renter, and information about the renter.

18. The rental return module of claim 15 wherein the communication from the client further comprises at least one of information about the rental, information about the source, and information about a renter operating the client.

19. The rental return module of claim 18 wherein the information about the renter further comprises a telephone number and an address of the renter.

20. The rental return module of claim 15 wherein the source determining module determines at least one of name of the source, telephone number of the source, address of the source, closing time of the source, directions to the source, hours of operation of the source, and contact at the source.

21. The rental return module of claim 15 further comprising a database maintaining information about at least one of the rental, the source of the rental, the renter, and the client.
